(19) United States
(12) Patent Application Publication
(10) Pub. No.: US 2015/0153859 A1
(43) Pub. Date: Jun. 4, 2015

(54) TFT DISPLAY TOUCH DEVICE

(71) Applicant: Rich IP Technology Inc., Taipei (TW)

(72) Inventors: Han-Chang CHEN, Taipei (TW); Yen-Hung TU, Taipei (TW); Chung-Lin CHIA, Taipei (TW); Jen-Chieh CHANG, Taipei (TW); Chih-Wen WU, Taipei (TW)

(21) Appl. No.: 14/540,631

(22) Filed: Nov. 13, 2014

(30) Foreign Application Priority Data
Dec. 4, 2013 (TW) 102144394

(51) Int. Cl. G06F 3/041

(52) U.S. Cl. CPC G06F 3/041

(57) ABSTRACT

A TFT display touch device, including: a TFT array, including: a plurality of thin film transistors, each having a source, a gate, and a drain, the drain being coupled with a capacitor; a plurality of gate connecting lines; and a plurality of source connecting lines; and a control unit, having a gate control unit and a source control unit, wherein, at least one of the gate control unit and the source control unit provides a hybrid voltage generation function, and at least one of the gate control unit and the source control unit provides a touch detection function, wherein the hybrid voltage generation function is used to provide a hybrid voltage source having a DC voltage component and an AC voltage component.

### BACKGROUND OF THE INVENTION

1. Field of the Invention

The present invention relates to a touch device, especially to a TFT (thin film transistor) display touch device.

2. Description of the Related Art

General touch devices have a touch module stacked on a screen. However, this kind of touch devices tends to have larger depths, which can fail to meet the market requirements on lightness and thinness, and can result in higher material cost.

To cope with this issue, one solution is to integrate two layers of same material, of which one layer belongs to a screen and the other layer belongs to a touch module, into a single layer. However, the depth of a touch device reduced by this kind of designs still cannot meet the requirements of some high end products.

Another solution is to integrate a touch function into a display, generally by adding extra electrodes on a display circuit layer to form touch capacitors. However, this kind of designs tends to reduce product yield rate and increase manufacturing cost.

To solve the foregoing problems, a novel, slim, and easy-to-manufacture touch device is needed.

### SUMMARY OF THE INVENTION

One objective of the present invention is to disclose a TFT display touch device, which is capable of providing a display function and/or a touch detection function by applying a hybrid voltage source to a TFT display structure.

Another objective of the present invention is to disclose a TFT display touch device, which is capable of using a top surface of a TFT display structure to provide a touch plane.

Another objective of the present invention is to disclose a TFT display touch device, which is capable of detecting a touch event by sensing a change in amplitude, phase, or frequency of an AC voltage of a hybrid voltage source.

Another objective of the present invention is to disclose a TFT display touch device, which is capable of providing multiple operation modes by turning on/off a DC voltage component and/or an AC voltage component of a hybrid voltage source.

Still another objective of the present invention is to disclose a TFT display touch device, which is capable of simplifying the structure of a touch device to reduce the depth, promote the yield rate, and cut down the cost thereof.

To attain the foregoing objectives, a TFT display touch device is proposed, including:

a TFT array, including:

a plurality of thin film transistors, each having a source, a gate, and a drain, the drain being coupled with a capacitor;

a plurality of gate connecting lines, each being coupled with the gates of a row of the thin film transistors; and

a plurality of source connecting lines, each being coupled with the sources of a column of the thin film transistors; and

a control unit, including:

a gate control unit, having plural first external connecting terminals for coupling with the plurality of gate connecting lines; and

a source control unit, having plural second external connecting terminals for coupling with the plurality of source connecting lines;

wherein, at least one of the gate control unit and the source control unit provides a hybrid voltage generation function, and at least one of the gate control unit and the source control unit provides a touch detection function, wherein the hybrid voltage generation function is used to provide a hybrid voltage source having a DC voltage component and an AC voltage component, the DC voltage component being used to control a display image of a TFT display, and the AC voltage component being used as a touch signal; and the touch detection function detects a touch event according to a parameter change of the touch signal.

In one embodiment, the TFT display is selected from a group consisting of TFT

LCD (thin film transistor liquid crystal display) and TFT OLED (thin film transistor organic light emitting diode).

In one embodiment, the gate control unit provides the hybrid voltage generation function and the source control unit provides the touch detection function.

In one embodiment, the gate control unit provides the hybrid voltage generation function and the touch detection function.

In one embodiment, the source control unit provides the hybrid voltage generation function and the gate control unit provides the touch detection function.

In one embodiment, the source control unit provides the hybrid voltage generation function and the touch detection function.

In one embodiment, both the gate control unit and the source control unit provide the hybrid voltage generation function, and both the gate control unit and the source control unit provide the touch detection function.

In one embodiment, when the control unit operates in a first operation mode, the control unit provides a display function and the touch detection function at the same time.

In one embodiment, when the control unit operates in a second operation mode, the control unit provides only the touch detection function.

In one embodiment, when the control unit operates in a third operation mode, the control unit provides only a display function.

In one embodiment, when the control unit operates in a fourth operation mode, the control unit will shut down both a display function and the touch detection function.

In one embodiment, the control unit includes a scan control unit for controlling a driving procedure for the TFT array.

To make it easier for our examiner to understand the objective of the invention, its structure, innovative features, and performance, we use preferred embodiments together with the accompanying drawings for the detailed description of the invention.

### BRIEF DESCRIPTION OF THE DRAWINGS

FIG. 1a illustrates a hybrid voltage source driving a signal connecting line to perform a touch detection procedure.

FIG. 1b shows an illustrative waveform of the hybrid voltage source of FIG. 1a.

FIG. 1c illustrates a hybrid voltage source driving a horizontal signal connecting line and a touch detection unit performing a touch detection procedure on a vertical signal connecting line.

FIG. 2 illustrates an embodiment of the TFT display touch device of the present invention.

FIG. 3 illustrates another embodiment of the TFT display touch device of the present invention.

FIG. 4 illustrates another embodiment of the TFT display touch device of the present invention.

FIG. 5 illustrates another embodiment of the TFT display touch device of the present invention.

FIG. 6 illustrates still another embodiment of the TFT display touch device of the present invention.

### DETAILED DESCRIPTION OF THE PREFERRED EMBODIMENTS

The present invention will be described in more detail hereinafter with reference to the accompanying drawings that show the preferred embodiments of the invention.

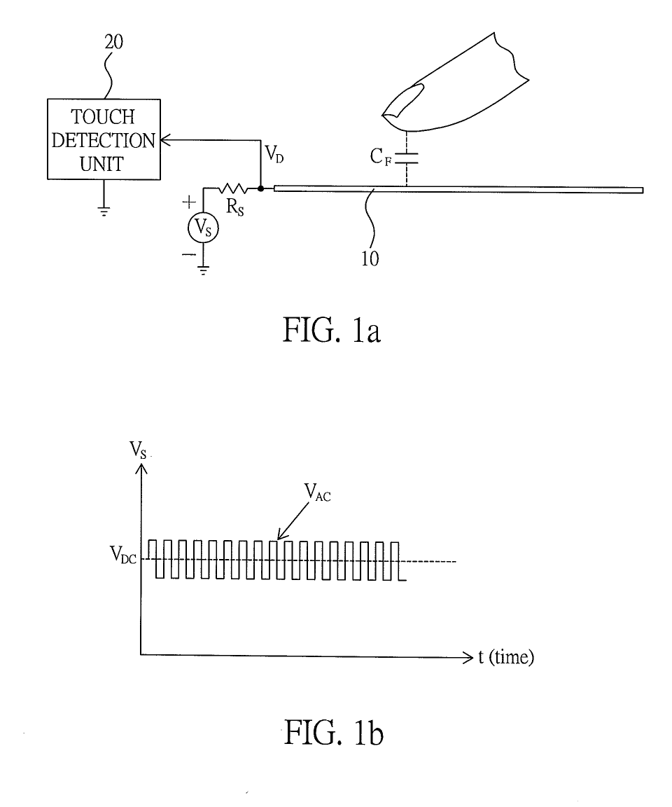

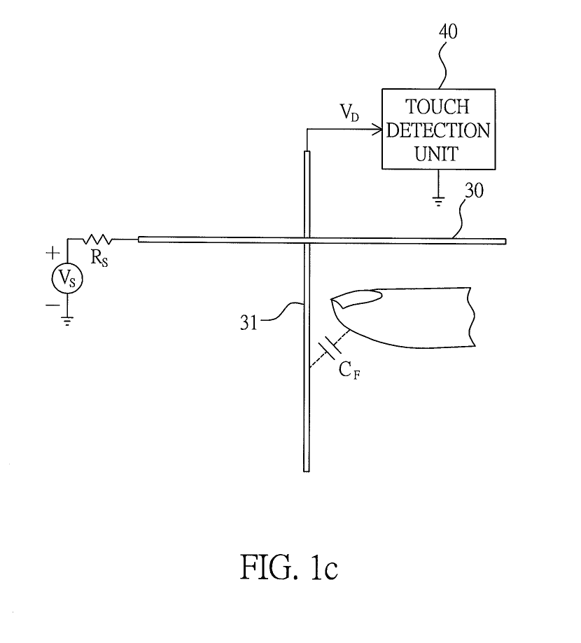

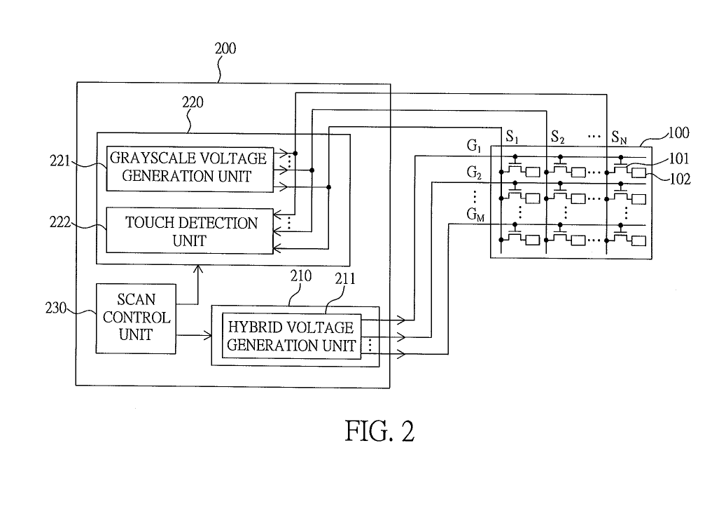

The principle of the present invention will be illustrated first. Please refer to FIG. 1a, which illustrates a hybrid voltage source driving a signal connecting line to perform a touch detection procedure. In FIG. 1a, a signal connecting line 10, which can be a gate connecting line or a source connecting line of a TFT array of a TFT display and the TFT display can be a TFT LCD or a TFT OLED display, is coupled with a voltage source V_{S} and a touch detection unit 20 respectively, wherein the voltage source V_{S} is a hybrid voltage source composed of a DC (direct current) voltage and an AC (alternating current) voltage, and an illustrative waveform of the voltage source V_{S} is shown in FIG. 1b. As illustrated in FIG. 1b, the voltage source V_{S} has a DC voltage V_{DC} and an AC voltage V_{AC} (although the AC voltage V_{AC} shown in FIG. 1b is of a square waveform, it can also be of a sine waveform or other AC waveforms), the DC voltage V_{DC} being used to control a display state of a display cell of the TFT display, and the AC voltage V_{AC} being used to perform a touch detection procedure.

When the TFT display is a TFT LCD, as a driving voltage higher than a threshold voltage has to be applied for more than a response time to make liquid crystal molecules twisted, therefore, as long as the peak-to-peak value of the AC voltage V_{AC} is smaller than the threshold voltage, or the half cycle period of the AC voltage V_{AC} is less than the response time, the AC voltage V_{AC} will not cause much impact on the display state of the display cell of the TFT LCD.

Besides, when the TFT display is a TFT OLED display, as the average brightness of an OLED is determined by the average current flowing through the OLED, therefore, the AC voltage V_{AC} can be used for touch detection without affecting the average brightness of the OLED.

As a result, when a finger approaches the signal connecting line 10 to induce an equivalent capacitance C_{F}, the touch detection unit 20 can detect the touch event by executing a touch detection function according to a parameter change of an AC voltage component of a voltage V_{D} at the signal connecting line 10 caused by the equivalent capacitance C_{F}, wherein, the parameter change can be amplitude change, phase change, or frequency change (when the AC voltage V_{AC} is generated by an oscillating circuit).

Besides, please refer to FIG. 1c, which illustrates a hybrid voltage source driving a horizontal signal connecting line and a touch detection unit performing a touch detection procedure on a vertical signal connecting line. In FIG. 1c, a horizontal signal connecting line 30, which is a gate connecting line of a TFT array of a TFT display and the TFT display can be a TFT LCD or a TFT OLED display, is coupled with a voltage source V_{S}; and a vertical signal connecting line 31, which is a source connecting line of the TFT array, is coupled with a touch detection unit 40, wherein the voltage source V_{S} is a hybrid voltage source composed of a DC voltage and an AC voltage, and an illustrative waveform of the voltage source V_{S} is shown in FIG. 1b. As illustrated in FIG. 1b, the voltage source V_{S} has a DC voltage V_{DC} and an AC voltage V_{AC} (although the AC voltage V_{AC} shown in FIG. 1b is of a square waveform, it can also be of a sine waveform or other AC waveforms), the DC voltage V_{DC} being used to control a display state of a display cell of the TFT display, and the AC voltage V_{AC} being used to perform a touch detection procedure.

As a result, when a finger approaches the vertical signal connecting line 31 to induce an equivalent capacitance C_{F}, the touch detection unit 40 can detect the touch event by executing a touch detection function according to a parameter change of an AC voltage component of a voltage V_{D} at the vertical signal connecting line 31 caused by the equivalent capacitance C_{F}, wherein, the parameter change can be amplitude change, phase change, or frequency change.

In addition, by enabling/disabling the DC component and/or the AC component of the hybrid voltage source, the TFT display can provide multiple operation modes, wherein, when the TFT display operates in a first operation mode, the DC component and the AC component of the hybrid voltage source are both enabled for providing a display function and the touch detection function at the same time; when the TFT display operates in a second operation mode, the DC component of the hybrid voltage source is disabled and the AC component of the hybrid voltage source is enabled, and only the touch detection function is provided; when the TFT display operates in a third operation mode, the DC component of the hybrid voltage source is enabled and the AC component of the hybrid voltage source is disabled, and only the display function is provided; and when the TFT display operates in a fourth operation mode, the DC component and the AC component of the hybrid voltage source are both disabled, and both the display function and the touch detection function are shut down.

Based on the principle elaborated above, the present invention proposes a TFT display touch device. Please refer to FIG. 2, which illustrates an embodiment of the TFT display touch device of the present invention. As illustrated in FIG. 2, the TFT display touch device includes a TFT array 100 and a control unit 200.

The TFT array 100 includes: a plurality of thin film transistors 101, each having a source, a gate, and a drain, the drain being coupled with a capacitor 102; a plurality of gate connecting lines G₁-G_{M}, each being coupled with the gates of a row of the thin film transistors 101; and a plurality of source connecting lines S₁-S_{N}, each being coupled with the sources of a column of the thin film transistors 101. The capacitor 102 is used store a voltage to control the state of a display cell, which can be the displayed grayscale of a liquid crystal display cell or the brightness of an OLED.

The control unit 200 includes a gate control unit 210, a source control unit 220, and a scan control unit 230.

The gate control unit 210 has a hybrid voltage generation unit 211 and a plurality of first external connecting terminals, wherein, the plurality of first external connecting terminals are used to couple with the plurality of gate connecting lines G₁-G_{M}, and the hybrid voltage generation unit 211 is used to apply a hybrid voltage source to at least one of the plurality of gate connecting lines G₁-G_{M}. The hybrid voltage source has a DC voltage component and an AC voltage component, the DC voltage component being used for controlling a display image of a TFT display, and the AC voltage component being used as a touch signal. Besides, the hybrid voltage generation unit 211 can use an active type circuit (including transistors or an amplifier) or a passive circuit to combine a DC voltage source and an AC voltage source into the hybrid voltage source, and both the DC voltage source and the AC voltage source can be enabled or disabled independently.

The source control unit 220 has a grayscale voltage generation unit 221, a touch detection unit 222, and a plurality of second external connecting terminals, wherein, the plurality of second external connecting terminals are used to couple with the plurality of source connecting lines S₁-S_{N}; the grayscale voltage generation unit 221 is used to provide a grayscale voltage (or gamma voltage) to at least one of the plurality of source connecting lines S₁-S_{N}; and the touch detection unit 222 is used to detect a touch event according to a parameter change of the touch signal. The parameter change can be an amplitude change, a phase change, or a frequency change.

The scan control unit 230 is used to control the operation timing of the gate control unit 210 and the source control unit 220.

The control unit 200 has multiple operation modes, wherein, when the control unit 200 operates in a first operation mode, the hybrid voltage generation unit 211 will output a hybrid voltage source having a DC component and an AC component, and the touch detection unit 212 will detect a parameter change of the AC component of the hybrid voltage source, so as to provide a display function and a touch detection function at the same time; when the control unit 200 operates in a second operation mode, the hybrid voltage generation unit 211 will output a hybrid voltage source having only an AC component, and the control unit 200 will provide only the touch detection function; when the control unit 200 operates in a third operation mode, the hybrid voltage generation unit 211 will output a hybrid voltage source having only a DC component, and the control unit 200 will provide only the display function; and when the control unit 200 operates in a fourth operation mode, the hybrid voltage generation unit 211 will disable the hybrid voltage source to shut down both the display function and the touch detection function. In addition, the control unit 200 can further include a communication interface for transmitting data with an information processing unit.

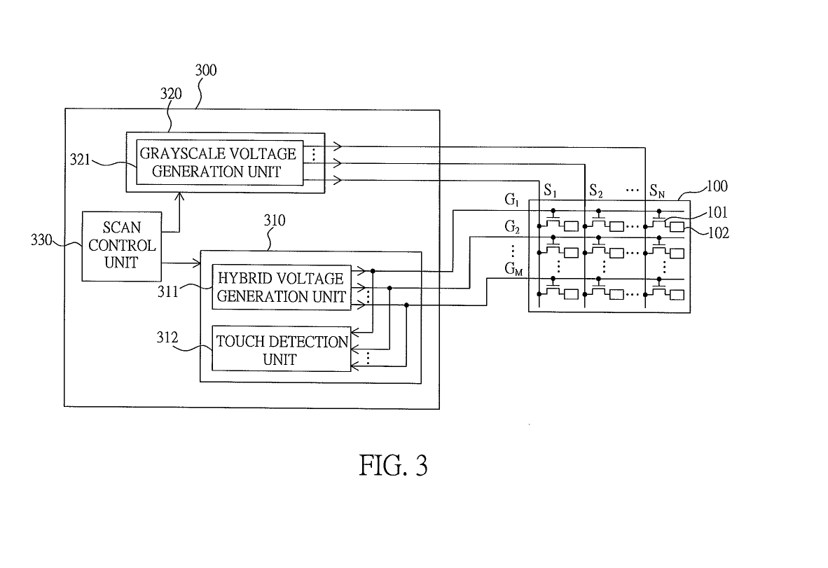

Please refer to FIG. 3, which illustrates another embodiment of the TFT display touch device of the present invention. As illustrated in FIG. 3, the TFT display touch device includes a TFT array 100 and a control unit 300.

The TFT array 100 includes: a plurality of thin film transistors 101, each having a source, a gate, and a drain, the drain being coupled with a capacitor 102; a plurality of gate connecting lines G₁-G_{M}, each being coupled with the gates of a row of the thin film transistors 101; and a plurality of source connecting lines S₁-S_{N}, each being coupled with the sources of a column of the thin film transistors 101. The capacitor 102 is used store a voltage to control the state of a display cell, which can be the displayed grayscale of a liquid crystal display cell or the brightness of an OLED.

The control unit 300 has a gate control unit 310, a source control unit 320, and a scan control unit 330.

The gate control unit 310 has a hybrid voltage generation unit 311, a touch detection unit 312, and a plurality of first external connecting terminals, wherein, the plurality of first external connecting terminals are used to couple with the plurality of gate connecting lines G₁-G_{M}; the hybrid voltage generation unit 311 is used to apply a hybrid voltage source to at least one of the plurality of gate connecting lines G₁-G_{M}, the hybrid voltage source having a DC voltage component and an AC voltage component, the DC voltage component being used for controlling a display image of a TFT display, and the AC voltage component being used as a touch signal; and the touch detection unit 312 is used to detect a touch event according to a parameter change of the touch signal, the parameter change being an amplitude change, a phase change, or a frequency change. Besides, the hybrid voltage generation unit 311 can use an active type circuit (including transistors or an amplifier) or a passive circuit to combine a DC voltage source and an AC voltage source into the hybrid voltage source, and both the DC voltage source and the AC voltage source can be enabled or disabled independently.

The source control unit 320 has a grayscale voltage generation unit 321 and a plurality of second external connecting terminals, wherein, the plurality of second external connecting terminals are used to couple with the plurality of source connecting lines S₁-S_{N}; the grayscale voltage generation unit 321 is used to provide a grayscale voltage (or gamma voltage) to at least one of the plurality of source connecting lines S₁-S_{N}.

The scan control unit 330 is used to control the operation timing of the gate control unit 310 and the source control unit 320.

The control unit 300 has multiple operation modes, wherein, when the control unit 300 operates in a first operation mode, the hybrid voltage generation unit 311 will output a hybrid voltage source having a DC component and an AC component, and the touch detection unit 312 will detect a parameter change of the AC component of the hybrid voltage source, so as to provide a display function and a touch detection function at the same time; when the control unit 300 operates in a second operation mode, the hybrid voltage generation unit 311 will output a hybrid voltage source having only an AC component, and the control unit 300 will provide only the touch detection function; when the control unit 300 operates in a third operation mode, the hybrid voltage generation unit 311 will output a hybrid voltage source having only a DC component, and the control unit 300 will provide only the display function; and when the control unit 300 operates in a fourth operation mode, the hybrid voltage generation unit 311 will disable the hybrid voltage source to shut down both the display function and the touch detection function. In addition, the control unit 300 can further include a communication interface for transmitting data with an information processing unit.

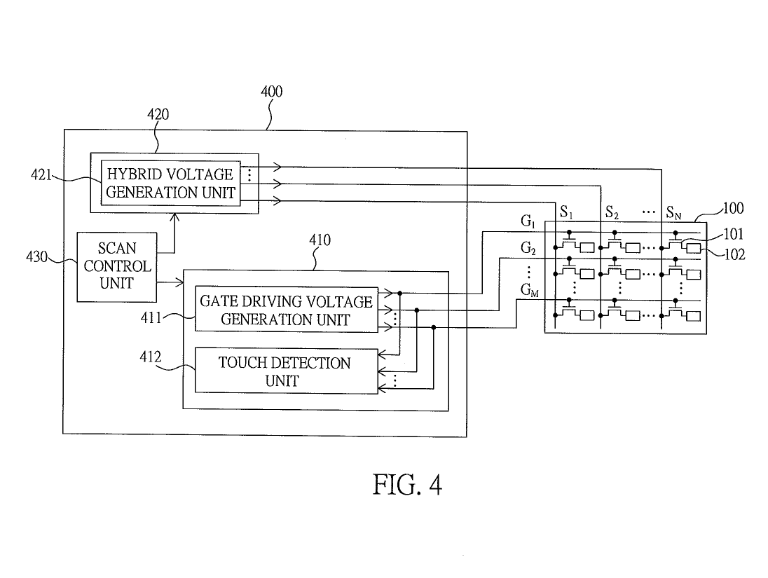

Please refer to FIG. 4, which illustrates another embodiment of the TFT display touch device of the present invention. As illustrated in FIG. 4, the TFT display touch device includes a TFT array 100 and a control unit 400.

The TFT array 100 includes: a plurality of thin film transistors 101, each having a source, a gate, and a drain, the drain being coupled with a capacitor 102; a plurality of gate connecting lines G₁-G_{M}, each being coupled with the gates of a row of the thin film transistors 101; and a plurality of source connecting lines S₁-S_{N}, each being coupled with the sources of a column of the thin film transistors 101. The capacitor 102 is used store a voltage to control the state of a display cell, which can be the displayed grayscale of a liquid crystal display cell or the brightness of an OLED.

The control unit 400 has a gate control unit 410, a source control unit 420, and a scan control unit 430.

The gate control unit 410 has a gate driving voltage generation unit 411, a touch detection unit 412, and a plurality of first external connecting terminals, wherein, the plurality of first external connecting terminals are used to couple with the plurality of gate connecting lines G₁-G_{M}; the gate driving voltage generation unit 411 is used to apply a gate driving voltage source to at least one of the plurality of gate connecting lines G₁-G_{M} to control the on/off switching of a row of the thin film transistors 101; and the touch detection unit 412 is used to detect a touch event according to a parameter change of at least one touch signal of the plurality of gate connecting lines G₁-G_{M}, the parameter change being an amplitude change, a phase change, or a frequency change.

The source control unit 420 has a hybrid voltage generation unit 421 and a plurality of second external connecting terminals, wherein, the plurality of second external connecting terminals are used to couple with the plurality of source connecting lines S₁-S_{N}; the hybrid voltage generation unit 421 is used to apply a hybrid voltage source to at least one of the plurality of source connecting lines S₁-S_{N}, the hybrid voltage source having a DC voltage component and an AC voltage component, the DC voltage component (a grayscale voltage or a gamma voltage) being used for controlling a display image of a TFT display, and the AC voltage component being used as a touch signal. The hybrid voltage generation unit 421 can use an active type circuit (including transistors or an amplifier) or a passive circuit to combine a DC voltage source and an AC voltage source into the hybrid voltage source, and both the DC voltage source and the AC voltage source can be enabled or disabled independently.

The scan control unit 430 is used to control the operation timing of the gate control unit 410 and the source control unit 420.

The control unit 400 has multiple operation modes, wherein, when the control unit 400 operates in a first operation mode, the hybrid voltage generation unit 421 will output a hybrid voltage source having a DC component and an AC component, and the touch detection unit 412 will detect a parameter change of the AC component of the hybrid voltage source, so as to provide a display function and a touch detection function at the same time; when the control unit 400 operates in a second operation mode, the hybrid voltage generation unit 421 will output a hybrid voltage source having only an AC component, and the control unit 400 will provide only the touch detection function; when the control unit 400 operates in a third operation mode, the hybrid voltage generation unit 421 will output a hybrid voltage source having only a DC component, and the control unit 400 will provide only the display function; and when the control unit 400 operates in a fourth operation mode, the hybrid voltage generation unit 421 will disable the hybrid voltage source to shut down both the display function and the touch detection function. In addition, the control unit 400 can further include a communication interface for transmitting data with an information processing unit.

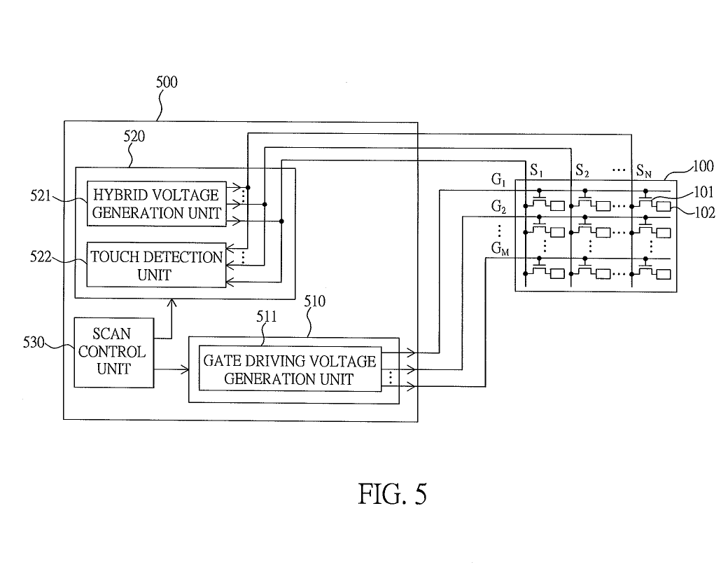

Please refer to FIG. 5, which illustrates another embodiment of the TFT display touch device of the present invention. As illustrated in FIG. 5, the TFT display touch device includes a TFT array 100 and a control unit 500.

The TFT array 100 includes: a plurality of thin film transistors 101, each having a source, a gate, and a drain, the drain being coupled with a capacitor 102; a plurality of gate connecting lines G₁-G_{M}, each being coupled with the gates of a row of the thin film transistors 101; and a plurality of source connecting lines S₁-S_{N}, each being coupled with the sources of a column of the thin film transistors 101. The capacitor 102 is used store a voltage to control the state of a display cell, which can be the displayed grayscale of a liquid crystal display cell or the brightness of an OLED.

The control unit 500 has a gate control unit 510, a source control unit 520, and a scan control unit 530.

The gate control unit 510 has a gate driving voltage generation unit 511 and a plurality of first external connecting terminals, wherein, the plurality of first external connecting terminals are used to couple with the plurality of gate connecting lines G₁-G_{M}; the gate driving voltage generation unit 511 is used to apply a gate driving voltage source to at least one of the plurality of gate connecting lines G₁-G_{M} to control the on/off switching of a row of the thin film transistors 101.

The source control unit 520 has a hybrid voltage generation unit 521, a touch detection unit 522, and a plurality of second external connecting terminals, wherein, the plurality of second external connecting terminals are used to couple with the plurality of source connecting lines S₁-S_{N}; the hybrid voltage generation unit 521 is used to apply a hybrid voltage source to at least one of the plurality of source connecting lines S₁-S_{N}, the hybrid voltage source having a DC voltage component and an AC voltage component, the DC voltage component (a grayscale voltage or a gamma voltage) being used for controlling a display image of a TFT display, and the AC voltage component being used as a touch signal; and the touch detection unit 522 is used to detect a touch event according to a parameter change of the touch signal, the parameter change being an amplitude change, a phase change, or a frequency change. Besides, the hybrid voltage generation unit 521 can use an active type circuit (including transistors or an amplifier) or a passive circuit to combine a DC voltage source and an AC voltage source into the hybrid voltage source, and both the DC voltage source and the AC voltage source can be enabled or disabled independently.

The scan control unit 530 is used to control the operation timing of the gate control unit 510 and the source control unit 520.

The control unit 500 has multiple operation modes, wherein, when the control unit 500 operates in a first operation mode, the hybrid voltage generation unit 521 will output a hybrid voltage source having a DC component and an AC component, and the touch detection unit 522 will detect a parameter change of the AC component of the hybrid voltage source, so as to provide a display function and a touch detection function at the same time; when the control unit 500 operates in a second operation mode, the hybrid voltage generation unit 521 will output a hybrid voltage source having only an AC component, and the control unit 500 will provide only the touch detection function; when the control unit 500 operates in a third operation mode, the hybrid voltage generation unit 521 will output a hybrid voltage source having only a DC component, and the control unit 500 will provide only the display function; and when the control unit 500 operates in a fourth operation mode, the hybrid voltage generation unit 521 will disable the hybrid voltage source to shut down both the display function and the touch detection function. In addition, the control unit 500 can further include a communication interface for transmitting data with an information processing unit.

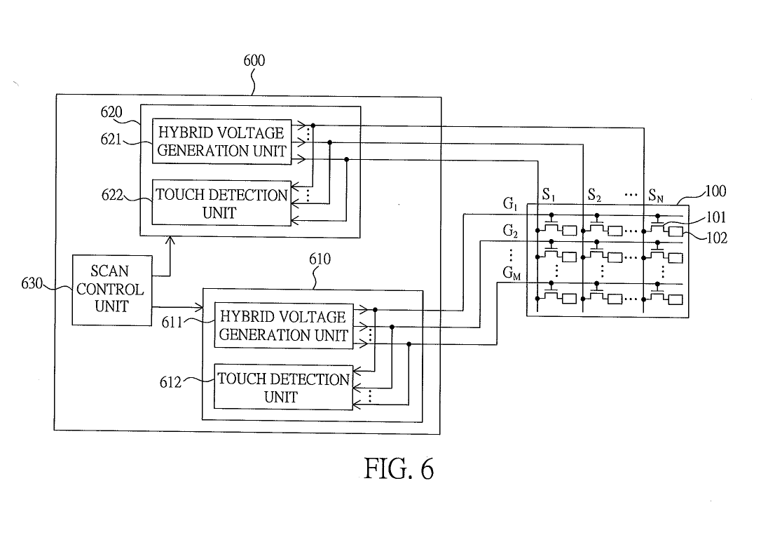

Please refer to FIG. 6, which illustrates still another embodiment of the TFT display touch device of the present invention. As illustrated in FIG. 6, the TFT display touch device includes a TFT array 100 and a control unit 600.

The TFT array 100 includes: a plurality of thin film transistors 101, each having a source, a gate, and a drain, the drain being coupled with a capacitor 102; a plurality of gate connecting lines G₁-G_{M}, each being coupled with the gates of a row of the thin film transistors 101; and a plurality of source connecting lines S₁-S_{N}, each being coupled with the sources of a column of the thin film transistors 101. The capacitor 102 is used store a voltage to control the state of a display cell, which can be the displayed grayscale of a liquid crystal display cell or the brightness of an OLED.

The control unit 600 has a gate control unit 610, a source control unit 620, and a scan control unit 630.

The gate control unit 610 has a hybrid voltage generation unit 611, a touch detection unit 612, and a plurality of first external connecting terminals, wherein, the plurality of first external connecting terminals are used to couple with the plurality of gate connecting lines G₁-G_{M}; the hybrid voltage generation unit 611 is used to apply a first hybrid voltage source to at least one of the plurality of gate connecting lines G₁-G_{M}, the first hybrid voltage source having a DC voltage component and an AC voltage component, the DC voltage component being used to control a display image of a TFT display, and the AC component being used as a first touch signal; and the touch detection unit 612 is used to detect a touch event according to a parameter change of the first touch signal of the plurality of gate connecting lines G₁-G_{M}, the parameter change being an amplitude change, a phase change, or a frequency change. Besides, the hybrid voltage generation unit 611 can use an active type circuit (including transistors or an amplifier) or a passive circuit to combine a DC voltage source and an AC voltage source into the first hybrid voltage source, and both the DC voltage source and the AC voltage source can be enabled or disabled independently.

The source control unit 620 has a hybrid voltage generation unit 621, a touch detection unit 622, and a plurality of second external connecting terminals, wherein, the plurality of second external connecting terminals are used to couple with the plurality of source connecting lines S₁-S_{N}; the hybrid voltage generation unit 621 is used to apply a second hybrid voltage source to at least one of the plurality of source connecting lines S₁-S_{N}, the second hybrid voltage source having a DC voltage component and an AC voltage component, the DC voltage component (a grayscale voltage or a gamma voltage) being used for controlling a display image of a TFT display, and the AC voltage component being used as a second touch signal; and the touch detection unit 622 is used to detect a touch event according to a parameter change of the second touch signal of the plurality of source connecting lines S the parameter change being an amplitude change, a phase change, or a frequency change. Besides, the hybrid voltage generation unit 621 can use an active type circuit (including transistors or an amplifier) or a passive circuit to combine a DC voltage source and an AC voltage source into the second hybrid voltage source, and both the DC voltage source and the AC voltage source can be enabled or disabled independently.

The scan control unit 630 is used to control the operation timing of the gate control unit 610 and the source control unit 620.

By enabling or disabling the DC voltage source and the AC voltage source of the hybrid voltage generation unit 612 respectively, and enabling or disabling the DC voltage source and the AC voltage source of the hybrid voltage generation unit 621 respectively, the control unit 600 can therefore possess multiple operation modes (the principle thereof has been elaborated above, so it will not be readdressed here).

Thanks to the novel designs mentioned above, the present invention possesses the following advantages:

1. The TFT display touch device of the present invention can provide a display function and/or a touch detection function by applying a hybrid voltage source to a TFT display structure.

2. The TFT display touch device of the present invention can use a top surface of a TFT display structure to provide a touch plane.

3. The TFT display touch device of the present invention can detect a touch event by sensing a change in amplitude, phase, or frequency of an AC voltage of a hybrid voltage source.

4. The TFT display touch device of the present invention can provide multiple operation modes by turning on/off a DC voltage component and/or an AC voltage component of a hybrid voltage source.

5. The TFT display touch device of the present invention can simplify the structure of a touch device to reduce the depth, promote the yield rate, and cut down the cost thereof.

While the invention has been described by way of examples and in terms of preferred embodiments, it is to be understood that the invention is not limited thereto.

To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance over the conventional structure and further complies with the patent application requirements and is submitted to the Patent and Trademark Office for review and granting of the commensurate patent rights.

What is claimed is:

1. A TFT display touch device, comprising:
a TFT array, including:
a plurality of thin film transistors, each having a source, a gate, and a drain, said drain being coupled with a capacitor;
a plurality of gate connecting lines, each being coupled with said gates of a row of said thin film transistors; and
a plurality of source connecting lines, each being coupled with said sources of a column of said thin film transistors; and
a control unit, including:
a gate control unit, having plural first external connecting terminals for coupling with said plurality of gate connecting lines; and
a source control unit, having plural second external connecting terminals for coupling with said plurality of source connecting lines;
wherein, at least one of said gate control unit and said source control unit provides a hybrid voltage generation function, and at least one of said gate control unit and said source control unit provides a touch detection function, wherein said hybrid voltage generation function is used to provide a hybrid voltage source having a DC voltage component and an AC voltage component, said DC voltage component being used to control a display image of a TFT display, and said AC voltage component being used as a touch signal; and said touch detection function detects a touch event according to a parameter change of said touch signal.

2. The TFT display touch device as claim 1, wherein said TFT display is selected from a group consisting of TFT LCD and TFT OLED display.

3. The TFT display touch device as claim 1, wherein said gate control unit provides said hybrid voltage generation function and said source control unit provides said touch detection function.

4. The TFT display touch device as claim 1, wherein said gate control unit provides said hybrid voltage generation function and said touch detection function.

5. The TFT display touch device as claim 1, wherein said source control unit provides said hybrid voltage generation function and said gate control unit provides said touch detection function.

6. The TFT display touch device as claim 1, wherein said source control unit provides said hybrid voltage generation function and said touch detection function.

7. The TFT display touch device as claim 1, wherein both said gate control unit and said source control unit provide said hybrid voltage generation function, and both said gate control unit and said source control unit provide said touch detection function.

8. The TFT display touch device as claim 1, wherein, when said control unit operates in a first operation mode, said control unit provides a display function and said touch detection function at the same time.

9. The TFT display touch device as claim 1, wherein, when said control unit operates in a second operation mode, said control unit provides only said touch detection function.

10. The TFT display touch device as claim 1, wherein, when said control unit operates in a third operation mode, said control unit provides only a display function.

11. The TFT display touch device as claim 1, wherein, when said control unit operates in a fourth operation mode, said control unit will shut down both a display function and said touch detection function.

12. The TFT display touch device as claim 1, wherein said control unit includes a scan control unit for controlling a driving procedure for said TFT array.
